(19) United States
(12) Patent Application Publication
(10) Pub. No.: US 2016/0047717 A1
(43) Pub. Date: Feb. 18, 2016

(54) METHOD, COMPUTER PROGRAM PRODUCT & SYSTEM

(71) Applicant: AKTIEBOLAGET SKF, Göteborg (SE)

(72) Inventor: Gerard MCGOOGAN, Philipston (GB)

(73) Assignee: AKTIEBOLAGET SKF, Göteborg (SE)

(21) Appl. No.: 14/782,372

(22) PCT Filed: Apr. 5, 2013
(86) PCT No.: PCT/EP2013/057178

§ 371 Date: Oct. 5, 2015

(51) Int. Cl. G01M 13/04; G01N 29/14

(52) U.S. Cl. CPC G01M 13/045; G01N 29/14

(57) ABSTRACT

A method for processing data obtained from a condition monitoring system, the method including steps of (a) obtaining an Acoustic Emission time waveform from at least one sensor and (b) digitally demodulating the Acoustic Emission time waveform.

### CROSS REFERENCE TO RELATED APPLICATION

This is a United States National Stage Application claiming the benefit of International Application Number PCT/EP2013/057178 filed on 05 Apr. 2013 (Apr. 05, 2013), which is incorporated herein by reference in its entirety.

### TECHNICAL FIELD

The present invention concerns a method, system and computer program product for processing data obtained from a condition monitoring system, such a condition monitoring system for monitoring and optionally predicting the residual life of a component, such as a bearing, i.e. for predicting when it is necessary or desirable to service, replace or refurbish (re-manufacture) the component.

### BACKGROUND OF THE INVENTION

Condition monitoring is the process of determining the condition of machinery while in operation. Condition monitoring enables the repair of problem components prior to failure and not only helps plant personnel reduce the possibility of catastrophic failure, but also allows them to order parts in advance, schedule manpower, and plan other repairs during downtime.

Components such as rolling-element bearings are often used in critical applications, wherein their failure in service would result in significant commercial loss to the end-user. It is therefore important to be able to predict the residual life of such a bearing, in order to plan intervention in a way that avoids failure in service, while minimizing the losses that may arise from taking the machinery in question out of service to replace the bearing.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

Bearings are selected for a specific application on the basis of a calculated or predicted residual life expectancy compatible with the expected type of service in the application in which they will be used. However, this type of life prediction is considered inadequate for the purpose of maintenance planning for several reasons.

One reason is that the actual operation conditions may be quite different from the nominal conditions. Another reason is that a bearing's residual life may be radically compromised by short-duration events or unplanned events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations and temperature to which a component, such as a bearing, is subjected in operational use, so as to be able to detect the first signs of impending failure.

High frequency stress wave events accompany the sudden displacement of small amounts of material in a very short period of time. In bearings high frequency stress wave events can be generated when impacting, fatigue cracking, scuffing or abrasive wear occurs. The frequency of the stress waves depends on the nature and material properties of the source. An acoustic emission (AE) sensor can consequently be used to detect such high frequency stress wave events and thereby provide important information for assistance in fault detection and severity assessment. Due to the dispersion and attenuation of the high frequency stress wave packet, it is desirable to locate a sensor as near to the initiation site as possible. A sensor may therefore be placed in the vicinity of, or on the bearing housing, preferably in the load zone.

Furthermore, a lubrication film can be compromised by excessive load, low viscosity of the lubricant or contamination of the lubricant with particulate material, or a lack of lubricant. If a lubrication film is compromised in this way, high frequency waves will be emitted by rolling contact of the bearing. The condition of the lubrication film can therefore be assessed by detecting high-frequency stress waves that propagate through the bearing rings and the surrounding structure in the event of a breakdown of the lubrication film.

The AE time waveform obtained from an AE sensor in such a condition monitoring system is usually amplified, passed through a precise analogue low pass filter and an analogue high pass filter, demodulated, passed through an anti-aliasing filter and then through a low frequency analogue to digital converter having an input frequency in the kHz range before it is transmitted to a central processing unit (CPU). Such conventional analogue enveloping systems have the following disadvantages: high current, low dynamic range, physically large, unsuitable for inclusion in an application-specific integrated circuit (ASIC) and poor temperature performance.

Furthermore, in a condition monitoring system data is obtained in the form of a time waveform (i.e. a graph of a varying quantity against time which usually consists of many samples) from at least one sensor. These time waveforms are usually transmitted and displayed to an analyst. This can however result in long transmission and display times and the data can be difficult to display or interpret. The transmission, display and interpretation of such data can require a significant amount of energy, time and expertise, and consequently decreases the rate at which measurements and analyses can be made.

### SUMMARY OF THE INVENTION

An object of the invention is to provide an improved method for processing data obtained from a condition monitoring system.

This object is achieved by a method comprising the steps of obtaining an Acoustic Emission (AE) time waveform from at least one sensor and digitally demodulating the AE time waveform.

Such a method may be used to instead of the conventional analogue demodulation methods and thereby avoids the above-mentioned disadvantages involved with the conventional analogue demodulation methods. As the precise filtering is done using digital circuitry, fewer operational amplifiers are required than for conventional analogue demodulation methods, hence lower current. Since fewer analogue filters are required the circuitry is smaller. Analogue rectification has a dynamic range of 40-50 dB, while digital rectification has a dynamic range that can exceed 70 dB. As the transmission path for Acoustic Emission can be lossy, digital rectification can also greatly improve the performance of a circuit. Furthermore, since precision analogue filters are not required, precision passive resistors and capacitors, which are difficult to fabricate in an integrated circuit, are consequently not required.

The at least one sensor may be configured to measure high frequency stress wave events (having a frequency of 100-500 kHz or higher, for example 20 kHz-3 Mz or higher).

The expression “high frequency stress wave event” as used in this document is intended to mean a short (i.e. up to 5 milliseconds (ms) in duration, typically 1 ms in duration) “burst” or “envelope” of high frequency stress waves (i.e. 100-500 kHz or higher) that is received as a unit, namely a wave packet. This wave packet may be processed electronically to generate an “envelope” that describes the duration and intensity of stress waves in the wave packet.

According to an embodiment of the invention the method comprises the step of transmitting, and/or displaying and/or storing the digitally demodulated AE time waveform instead of the AE time waveform obtained from the at least one sensor. Such a method avoids the need to transmit and/or display the whole AE time waveform from the at least one sensor and reduces the amount of data that needs to be transmitted by transmitting only the digitally demodulated signal. This leads to a significant reduction of the data that needs to be transmitted and/or displayed. Transmission, display and data processing times will therefore be shorter, less energy will be required for transmission, display and processing, which consequently results in extending the sensor battery life, or reducing the sensor battery size or power generation requirement.

A user will be more quickly warned of deterioration in the condition of a component being monitored and poor installation or poor operating practices, such as misalignment, imbalance, high vibration, lack of lubrication and contamination in the lubricant, etc., which would reduce the residual life of the component if left uncorrected, will be more quickly identified.

According to another embodiment of the invention the method comprises the step of passing the AE time waveform through a digital high pass filter (that has the same response as the analogue filter that is typically 100 kHz) and a digital low pass filter (that also has the same response as the analogue filter, having a cutoff frequency of 500 kHz for example) before the step of digitally demodulating the AE time waveform.

According to a further embodiment of the invention the method comprises the step of passing the AE time waveform through a digital low pass filter after the step of digitally demodulating the AE time waveform.

According to an embodiment of the invention the method comprises the step of filtering the AE time waveform using an anti-aliasing filter (having a passband of typically 2 kHz for example) to restrict the bandwidth of the AE time waveform to approximately satisfy the sampling theorem, before the step of digitally demodulating the AE time waveform.

According to another embodiment of the invention the method comprises the step of amplifying the AE time waveform before the step of digitally demodulating the AE time waveform.

According to a further embodiment of the invention the method comprises the step of passing the AE time waveform through a high frequency analogue to digital converter (ADC) having an input frequency in the MHz range, such as 2 MHz for example, before the step of digitally demodulating the AE time waveform.

According to an embodiment of the invention the method comprises the step of passing the digitally demodulated AE time waveform wirelessly through a wireless communication network.

According to another embodiment of the invention the method comprises the step of electronically recording the digitally demodulated AE time waveform in a database.

According to another embodiment of the invention the method comprises the step of digitally rectifying the AE time waveform.

According to a further embodiment of the invention the condition monitoring system is arranged to monitor at least one bearing, such as a rolling element bearing. The rolling bearing may be any one of a cylindrical roller bearing, a spherical roller bearing, a toroidal roller bearing, a taper roller bearing, a conical roller bearing or a needle roller bearing.

The present invention also concerns a computer program product that comprises a computer program containing computer program code means arranged to cause a computer or a processor to execute the steps of a method according to any of the embodiments of the invention, stored on a computer-readable medium or a carrier wave.

The present invention further concerns a system for processing data obtained from a condition monitoring system comprising at least one sensor arranged to provide an Acoustic Emission (AE) time waveform. The system comprises a processing unit configured to carry out at least one of the steps of a method according to any of the embodiments of the invention.

According to an embodiment of the invention the processing unit is arranged in an integrated circuit (IC), such as an application-specific integrated circuit (ASIC) or a field programmable gate array (FPGA).

It should be noted that the method, computer program and system according to the present invention may be used to monitor at least one component, such as a bearing during the component's manufacture, after the component's manufacture and before the component's use, during the component's use, during a period when the component is not in use and/or during the transportation of the component. A complete history log of a component may thereby be created. Accordingly, as a result of having condition status and/or residual life data accumulated over the component's life, starting with its very manufacturing all the way up to the present, a more accurate prediction can be made regarding the residual life of an individual component at any point in its life-cycle. An analyst or end user may be notified of relevant facts including the time at which it is advisable to replace or refurbish the component.

The method, system and computer program product according to the present invention may be used to monitor and optionally predict the residual life of at least one component, such as a bearing, used in automotive, aerospace, railroad, mining, wind, marine, metal producing and other machine applications which require high wear resistance and/or increased fatigue and tensile strength.

### BRIEF DESCRIPTION OF THE DRAWINGS

The present invention will hereinafter be further explained by means of non-limiting examples with reference to the appended figures where;

FIG. 1 shows a system according to an embodiment of the invention;

FIG. 2 is a flow chart showing the steps of a method according to the prior art; and

FIG. 3 is a flow chart showing the steps of a method according to an embodiment of the invention.

It should be noted that the drawings have not been drawn to scale and that the dimensions of certain features have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

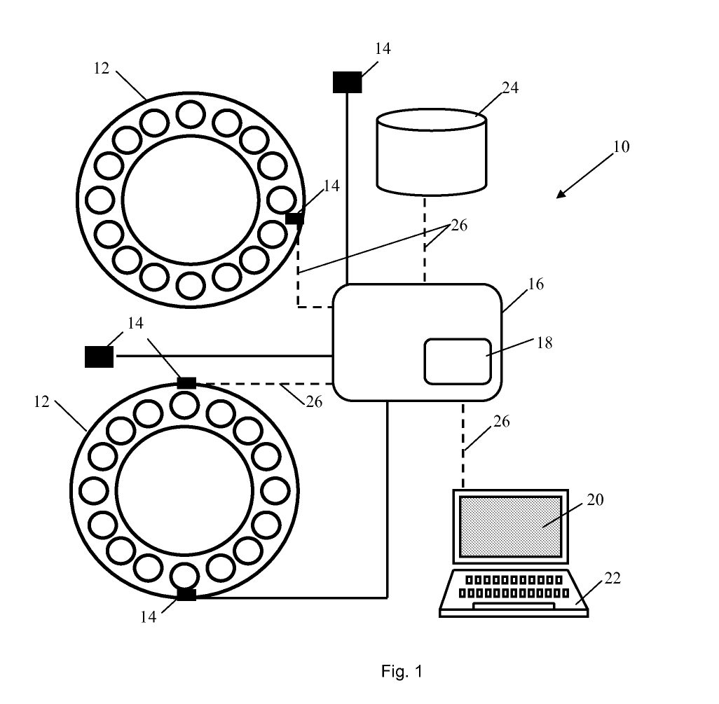

FIG. 1 shows a system 10 for monitoring the condition, and optionally predicting the residual life of a plurality of bearings 12 during their use. The illustrated embodiment shows two rolling element bearings 12, the system 10 according to the present invention may however be used to monitor and optionally predict the residual life of one or more components of any type, and not necessarily all of the same type or size. The system 10 comprises a plurality of sensors 14 configured to obtain data concerning one or more of the factors that influence the residual life of each bearing 12. A sensor 14 may be integrated with a bearing 12, it may be placed in the vicinity of the bearing 12 or remotely from the bearing.

The inner ring and/or outer ring of a bearing 12, which can be monitored using a system or method according to an embodiment of the invention, may be of any size and have any load-carrying capacity. An inner ring and/or an outer ring may for example have a diameter up to a few metres and a load-carrying capacity up to many thousands of tonnes.

The system 10 comprises a plurality of AE sensors 14 configured to measure high frequency stress wave events (having a frequency of 100-500 kHz or higher, for example 20 kHz-3 Mz or higher). Data may be obtained periodically, substantially continuously, randomly, on request, or at any suitable time.

A sensor 14 may be embedded in the bearing ring or attached externally to the bearing housing to monitor a lubricant condition. Lubricant can be degraded by contamination in several ways. For example, a lubricant film may fail to protect a bearing 12 against corrosion, either because of its water content or the entrainment of corrosive materials, e.g., acid, salt, etc. As another example, a lubricant film may be contaminated with solid material that has an abrasive effect on the bearing's raceway. A lubrication film can also be compromised by excessive load, low viscosity of the lubricant or contamination of the lubricant with particulate material, or a lack of lubricant. The condition of the lubrication film can be assessed by detecting high-frequency stress waves that propagate through the bearing rings and the surrounding structure in the event of a breakdown of the lubrication film.

The system 10 in the illustrated embodiment comprises a processing unit 16 arranged to digitally demodulate the AE time waveform, and transmission means 18 arranged to transmit the digitally demodulated AE time waveform to a display means 20 and/or a CPU or device 22 used by a user or analyst and/or a database 24 where the demodulated AE time waveform may be electronically recorded. Data may be transmitted to and from the sensors 14, and to and from the processing means 16 in a wired or wireless (26) manner over a wireless communication network.

The database 20 may be maintained by the manufacturer of the bearings 12. The residual life data gathered in the database 20 for a whole batch of bearings 12 enables the manufacturer to extract further information, e.g., about relationships between types or environments of usage versus rates of change of residual life, so as to further improve the service to the end-user.

The system 10 may also comprise a prediction unit (not shown) configured to predict the residual life of each bearing 12 using the recorded data in the database 24 and a mathematical residual life predication model.

It should be noted that not all of the components of the system 10 necessarily need to be located in the vicinity of the bearings 12. For example, the database 24 and/or user device 22 may located at a remote location and communicate with at least one data processing unit 16 located in the same or a different place to the bearings 12 by means of a server for example.

It should also be noted that the at least one data processing unit 16, the transmission means 18 and/or the database 24 need not necessarily be separate units but may be combined in any suitable manner. For example a personal computer may be used to carry out a method concerning the present invention.

The digitally demodulated AE time waveform may be used to make a prediction of the residual life of a bearing 12. Once such a prediction has been made, it may be displayed on display means 20, and/or sent to a CPU or user device 22, bearing manufacturer, database 20 and/or another prediction unit. Notification of when it is advisable to service, replace or refurbish one or more bearings 12 being monitored by the system 10 may be made in any suitable manner, such as via a communication network, via an e-mail or telephone call, a letter, facsimile, alarm signal, or a visiting representative of the manufacturer.

The prediction of the residual life of a bearing 12 may be used to inform a user of when he/she should replace the bearing 12. Intervention to replace the bearing 12 is justified, when the cost of intervention (including labour, material and loss of, for example, plant output) is justified by the reduction in the risk cost implicit in continued operation. The risk cost may be calculated as the product of the probability of failure in service on the one hand, and the financial penalty arising from such failure in service, on the other hand.

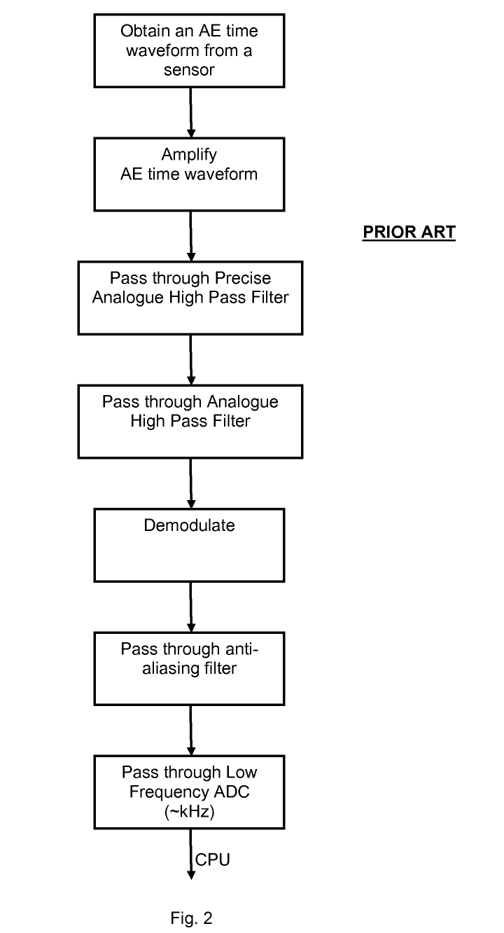

FIG. 2 is a flow chart showing the steps of an analogue demodulation method according to the prior art. The conventional method comprises the steps of obtaining an AE time waveform from an AE sensor 14, amplifying the AE time waveform to increase the gain, passing the AE time wavefrom through a precise analogue low pass filter and an analogue high pass filter, analogue demodulating the AE time waveform, passing the AE time waveform through an anti-aliasing filter and then through a low frequency analogue to digital converter (ADC) having an input frequency in the kHz range before it is transmitted to a central processing unit (CPU).

The aim of such conventional analogue demodulation is to transfer an analogue baseband (or lowpass) signal over an analogue bandpass channel at a different frequency, for example over a limited frequency band in the kHz range. This method is suitable for vibration measurements but not for Acoustic Emission (AE) measurements because the frequencies involved in AE measurements are much higher than in vibration measurements and require sample rates that are at least ten times higher than the sample rates used in vibration measurements.

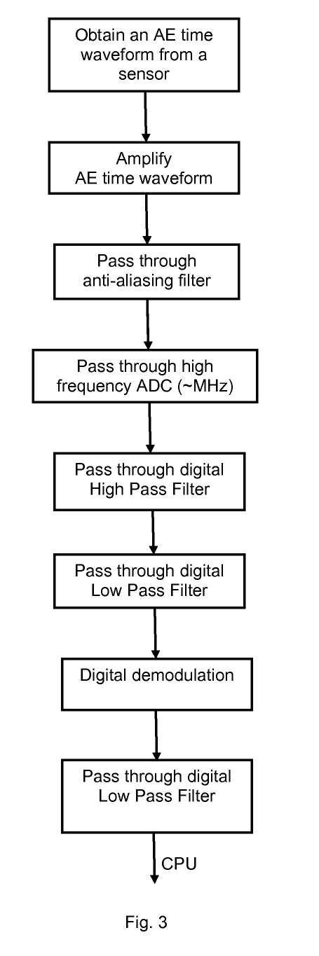

FIG. 3 is a flow chart showing the steps of a digital demodulation method according to an embodiment of the present invention. The method comprises the steps of obtaining an AE time waveform from an AE sensor 14, amplifying the AE time waveform to increase the gain, passing the AE time waveform through an anti-aliasing filter, passing the AE time waveform through a high frequency analogue to digital converter (ADC) having an input frequency in the MHz range, passing the AE time waveform through a digital high pass filter and a digital low pass filter, digitally demodulating the AE time waveform, passing the digitally demodulated AE time waveform through a digital low pass filter and transmitting the digitally demodulated AE time waveform to a central processing unit (CPU).

It should be noted that some of the steps prior to and after the digital demodulation step may be omitted. The order in which some or all of the steps are carried out may also be changed.

Such a method may be carried out by a system according to the present invention in which the necessary components are arranged on an integrated circuit, such as an ASIC or an FPGA. Conventional analogue enveloping has been used to reduce the bandwidth of an incoming signal from about 500 kHz to about 5 kHz for example. Historically it has been difficult to sample at frequencies greater than 1 MHz. However, the method according to the present invention used low power, high speed analogue to digital converters (ADCs) combined with power efficient digital decimation to produce more accurate results.

A key problem with conventional analogue enveloping is the linearity of the rectification circuit, which is poor at low levels. Digital rectification means the dynamic range of the product is greatly reduced. This is important as the attenuation of Acoustic Emission can be variable in the real world. Poor dynamic range can mean that AE time waveforms that depict problems can be missed.

Further modifications of the invention within the scope of the claims would be apparent to a skilled person. Even though the described embodiments are directed to a method, system and computer program product for monitoring at least one component such as a bearing, such a method, system and computer program product may be used for monitoring and optionally predicting the residual life of another component of rotating machinery, such as a gear wheel.

1. A method for processing data obtained from a condition monitoring system, the method comprising steps of:
obtaining an Acoustic Emission time waveform from at least one sensor: and
digitally demodulating the Acoustic Emission time waveform.

2. The method according to claim 1, the method further comprising a step of at least one of transmitting, displaying, and storing the digitally demodulated Acoustic Emission time waveform instead of the Acoustic Emission time waveform obtained from the at least one sensor.

3. The method according to claim 1, the method further comprising a step of passing the Acoustic Emission time waveform through a digital high pass filter and a digital low pass filter before the step of digitally demodulating the Acoustic Emission time waveform.

4. The method according to claim 1, the method further comprising a step of passing the Acoustic Emission time waveform through a digital low pass filter after the step of digitally demodulating the Acoustic Emission time waveform.

5. The method according to claim 1, the method further comprising a step of filtering the Acoustic Emission time waveform using an anti-aliasing filter before the step of digitally demodulating the Acoustic Emission time waveform.

6. The method according to claim 1, the method further comprising a step of amplifying the Acoustic Emission time waveform before the step of digitally demodulating the Acoustic Emission time waveform.

7. The method according to claim 1, the method further comprising a step of passing the Acoustic Emission time waveform through a high frequency analogue to digital converter having an input frequency in the MHz before the step of digitally demodulating the Acoustic Emission time waveform.

8. The method according to claim 1, the method further comprising a step of passing the digitally demodulated Acoustic Emission time waveform wirelessly through a wireless communication network.

9. The method according to claim 1, the method further comprising a step of electronically recording the digitally demodulated Acoustic Emission time waveform in a database.

10. The method according to claim 1, the method further comprising a step of digitally rectifying the Acoustic Emission time waveform.

11. The method according to claim 1, wherein the condition monitoring system is arranged to monitor at least one bearing.

12. A computer program product, comprising:
a computer program containing computer program code arranged to cause one of (a) a computer or (b) a processor to execute steps of:
obtaining an Acoustic Emission time waveform from at least one sensor; and
digitally demodulating the Acoustic Emission time waveform,
wherein the computer program is stored on a computer-readable medium or a carrier wave.

13. A system for processing data obtained from a condition monitoring system including at least one sensor arranged to provide an Acoustic Emission time waveform, the data processing system comprising:
a processing unit configured to carry steps of:
obtaining an Acoustic Emission time waveform from at least one sensor; and
digitally demodulating the Acoustic Emission time waveform.

14. The system according to claim 13, the processing unit is arranged in an integrated circuit.

15. The system according to claim 13, wherein the processing unit is arranged in one of (a) an application-specific integrated circuit or (b) a field programmable gate array.

16. The method according to claim 1, wherein the condition monitoring system is arranged to monitor at least one.
